(19) United States
(12) Patent Application Publication
(10) Pub. No.: US 2025/0368206 A1
(43) Pub. Date: Dec. 4, 2025

(54) DRIVING EVALUATION SYSTEM, DRIVING EVALUATION DEVICE, DRIVING EVALUATION METHOD, AND STORAGE MEDIUM

(71) Applicant: HONDA MOTOR CO., LTD., Tokyo (JP)

(72) Inventor: Masayuki Sato, Wako-shi (JP)

(21) Appl. No.: 19/208,664

(22) Filed: May 15, 2025

(30) Foreign Application Priority Data
May 29, 2024 (JP) 2024-087265

(51) Int. Cl. B60W 40/09; B60K 35/10; B60K 35/28; G01C 21/36

(52) U.S. Cl. CPC B60W 40/09; B60K 35/10; B60K 35/28; G01C 21/3655; B60W 2555/20

(57) ABSTRACT

A driving evaluation system includes a vehicle, a first terminal device that is used by a driver of the vehicle, a second terminal device that is used by a specific person correlated with the driver, and a driving evaluation device that evaluates a driving behavior of the driver. The driving evaluation system further includes an acquirer configured to acquire information on the driving behavior of the driver, an evaluator configured to evaluate the driving behavior of the driver on the basis of the information acquired by the acquirer, and a provider configured to provide an evaluation result to at least one of the vehicle and the first terminal device that is used by the driver. The provider provides the evaluation result to at least one of the vehicle and the first terminal device via the second terminal device that is used by the specific person correlated with the driver.

### CROSS-REFERENCE TO RELATED APPLICATION

Priority is claimed on Japanese Patent Application No. 2024-087265, filed May 29, 2024, the content of which is incorporated herein by reference.

### BACKGROUND

### Field of the Invention

The present invention relates to a driving evaluation system, a driving evaluation device, a driving evaluation method, and a storage medium.

### Description of Related Art

Recently, countermeasures for providing an access to a sustainable transportation system in which vulnerable persons out of traffic participants are considered have been actively studied. In order to realize such countermeasures, focus has been concentrated on research and development for further improving safety or convenience of traffic through research and development on preventive safety technology. In this regard, recently, a technique of estimating a training route appropriate for a target driver on the basis of a result of driving aptitude evaluation of the target driver and results of route evaluation of traveling routes calculated from driving characteristics of a plurality of drivers and providing the estimated training route to the target driver has come known (for example, Japanese Unexamined Patent Application, First Publication No. 2012-128344).

### SUMMARY

In such preventive safety technology, when driving evaluation is performed on the basis of an averaging result of route evaluation of traveling routes from driving characteristics of a plurality of drivers, driving evaluation may change greatly according to differences from a road shape or a traffic environment at the time of actual traveling, and thus there is a problem in that there is a likelihood that an appropriate driving evaluation result will not be acquired and agreement or acceptability of a driver will be damaged.

An objective of the present invention is to solve the aforementioned problem and to provide a driving evaluation system, a driving evaluation device, a driving evaluation method, and a storage medium that can more improve agreement or acceptability of a driver with respect to driving evaluation. Another objective thereof is to contribute to advancement of a sustainable transportation system.

A driving evaluation system, a driving evaluation device, a driving evaluation method, and a storage medium according to the present invention employ the following configurations.

(1) According to an aspect of the present invention, there is provided a driving evaluation system including a vehicle, a first terminal device that is used by a driver of the vehicle, a second terminal device that is used by a specific person correlated with the driver, and a driving evaluation device that evaluates a driving behavior of the driver, the driving evaluation system further including: an acquirer configured to acquire information on the driving behavior of the driver; an evaluator configured to evaluate the driving behavior of the driver on the basis of the information acquired by the acquirer; and a provider configured to provide an evaluation result from the evaluator to at least one of the vehicle and the first terminal device that is used by the driver, wherein the provider provides the evaluation result from the evaluator to at least one of the vehicle and the first terminal device via the second terminal device that is used by the specific person correlated with the driver.

(2) According to another aspect of the present invention, there is provided a driving evaluation device including: an acquirer configured to acquire information on a driving behavior of a driver of a vehicle; an evaluator configured to evaluate the driving behavior of the driver on the basis of the information acquired by the acquirer; and a provider configured to provide an evaluation result from the evaluator to at least one of the vehicle and a first terminal device that is used by the driver, wherein the provider provides the evaluation result from the evaluator to at least one of the vehicle and the first terminal device via a second terminal device that is used by a specific person correlated with the driver.

(3) In the aspect of (2), the evaluator acquires a result of primary driving evaluation for evaluating the driver's driving behavior on the basis of the information acquired by the acquirer and a result of secondary driving evaluation for allowing the specific person to evaluate the driver's driving behavior in the result of primary driving evaluation, and the provider provides at least one of the result of primary driving evaluation and the result of secondary driving evaluation to at least one of the vehicle and the first terminal device on the basis of a request from the driver.

(4) In the aspect of (2), the driving evaluation device further includes a register configured to register information of one or more specific persons, and the provider provides the evaluation result from the evaluator to the second terminal device which is used by the specific person designated by the driver out of the one or more specific persons registered in the register.

(5) In the aspect of (2), the evaluator quantitatively analyzes the driver's driving behavior in a route which is used daily by the driver, estimates a factor causing change of evaluation of the driving behavior on the basis of a result of analysis, and determines at least one of details of driving advice for the driver and a timing at which the driver is notified of the driving advice on the basis of a result of estimation.

(6) In the aspect of (5), the acquirer acquires a surrounding environment of the vehicle and schedule information of the driver, and the evaluator estimates the factor causing change of evaluation of the driving behavior on the basis of the result of analysis, the surrounding environment, the driver's driving conditions included in the information on the driving behavior, and the schedule information.

(7) In the aspect of (3), the provider provides an incentive to the specific person who has performed the secondary driving evaluation.

(8) In the aspect of (2), the acquirer acquires a social score for the driver, and the provider updates the social score according to the result of evaluation of the driver's driving behavior.

(9) In the aspect of (2), the provider provides an incentive to the driver according to the social score of the driver.

(10) According to another aspect of the present invention, there is provided a driving evaluation method that is performed by a computer, the driving evaluation method including: acquiring information on a driving behavior of a driver of a vehicle; evaluating the driving behavior of the driver on the basis of the acquired information; and providing an evaluation result to at least one of the vehicle and a first terminal device that is used by the driver via a second terminal device that is used by a specific person correlated with the driver.

(11) According to another aspect of the present invention, there is provided a non-transitory computer-readable storage medium storing a program, the program causing a computer perform: acquiring information on a driving behavior of a driver of a vehicle; evaluating the driving behavior of the driver on the basis of the acquired information; and providing an evaluation result to at least one of the vehicle and a first terminal device that is used by the driver via a second terminal device that is used by a specific person correlated with the driver.

According to the aspects of (1) to (11), it is possible to more improve agreement or acceptability of a driver with respect to driving evaluation.

### BRIEF DESCRIPTION OF THE DRAWINGS

FIG. 1 is a diagram illustrating an example of a configuration of a driving evaluation system including a driving evaluation device according to an embodiment.

FIG. 2 is a diagram illustrating an example of a functional configuration of a vehicle system that is mounted in a vehicle M.

FIG. 3 is a diagram illustrating an example of a functional configuration of a first terminal device.

FIG. 4 is a diagram illustrating an example of a functional configuration of the driving evaluation device.

FIG. 5 is a diagram illustrating an example of details of a driver information DB.

FIG. 6 is a diagram illustrating an example of details of a driving behavior history DB.

FIG. 7 is a diagram illustrating an example of details of an evaluation result DB.

FIG. 8 is a diagram illustrating an example of details of an advice information DB.

FIG. 9 is a diagram illustrating an example of an image including information on a primary driving evaluation result.

FIG. 10 is a diagram illustrating an example of an image including information on a driving evaluation result which a driver is notified of.

FIG. 11 is a sequence diagram illustrating an example of a processing sequence that is performed by the driving evaluation system according to the embodiment.

FIG. 12 is a diagram illustrating an example of functions of a driving support device according to a modified example of the embodiment.

### DESCRIPTION OF EMBODIMENTS

Hereinafter, a driving evaluation system, a driving evaluation device, a driving evaluation method, and a storage medium according to an embodiment of the present invention will be described with reference to the accompanying drawings.

### [System Configuration]

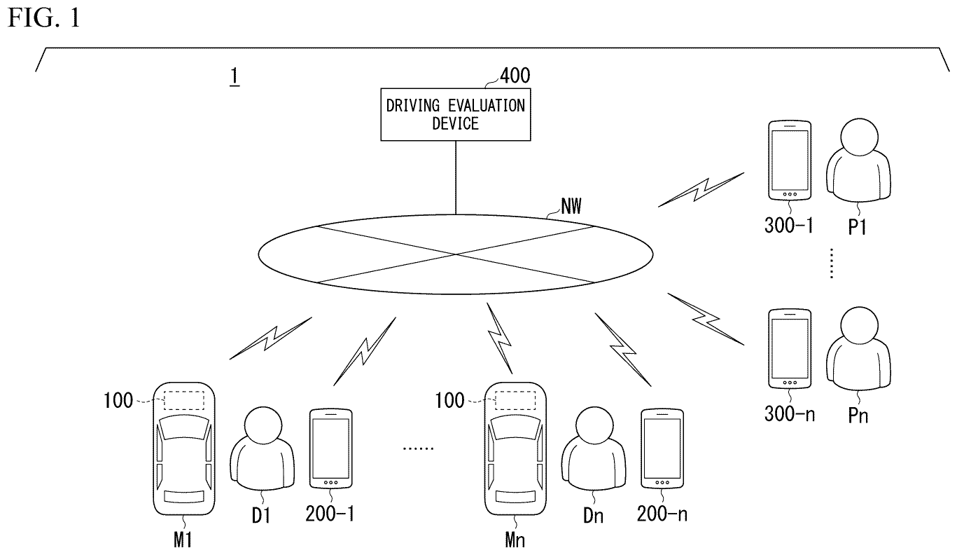

FIG. 1 is a diagram illustrating an example of a configuration of a driving evaluation system 1 including a driving evaluation device according to an embodiment. The driving evaluation system 1 includes, for example, one or more vehicles M1 to Mn, first terminal devices 200-1 to 200-n which are used by drivers D1 to Dn driving the vehicles M1 to Mn, second terminal devices 300-1 to 300-n which are used by specific persons P1 to Pn correlated with drivers registered in the driving evaluation system 1, and a driving evaluation device 400. In the following description, the vehicles M1 to Mn are referred to as “vehicles M” when they are not distinguished. The same is true of the drivers D, the first terminal devices 200, the specific person P, and the second terminal devices 300. The vehicles M (more specifically, vehicle systems 100 mounted in the vehicles M), the first terminal devices 200, the second terminal devices 300, and the driving evaluation device 400 communicate with each other, for example, via a network NW. The network NW includes, for example, a cellular network, a Wi-Fi network, Bluetooth (registered trademark), the Internet, a wide area network (WAN), a local area network (LAN), a public communication line, a provider device, a dedicated circuit line, and a wireless base station. The vehicle M may directly communicate with the first terminal device 200 via a short-range communication network such as a Wi-Fi network or Bluetooth.

The vehicle M is, for example, a vehicle with two wheels, three wheels, or four wheels, and a drive source thereof is an internal combustion engine such as a diesel engine or a gasoline engine, an electric motor, or a combination thereof. The electric motor operates using electric power generated by a power generator connected to the internal combustion engine or using electric power discharged from a secondary battery or a fuel cell. The vehicle M is caused to travel through manual driving of a driver D, but may be a vehicle in which a driving support function can operate. The driving support function includes, for example, a road departure mitigation (RDM) system, a forward collision warning (FCW) system, and a collision mitigation braking system (CMBS), but is not limited to these functions. RDM is a lane departure warning for prompting a driver D to pay attention and notifying that the driver D avoids departure (protruding) from a traveling lane by indication, warning, or the like when the vehicle M departs from the lane (protrudes from a road marking line for defining the lane). FCW is a function of predicting a risk of collision with a vehicle in front of the vehicle M and outputting a warning. CMBS is a function of prompting the driver D to pay attention by indication, warning, or the like when there is a risk of collision of the vehicle M with a nearby obstacle (another vehicle or a pedestrian) and supporting collision avoidance or damage reduction by performing at least one of steering control and acceleration/deceleration control when the vehicle M further approaches the obstacle.

The vehicle M acquires information on a driving behavior (hereinafter referred to as “driving behavior information” according to necessity) of the driver D of the vehicle M and transmits the acquired information to the driving evaluation device 400. The driving behavior information includes, for example, information on a driving operation on the vehicle M performed by the driver D or information indicating driving conditions of the driver D. The driving behavior information may include, for example, operation details of onboard devices such as amounts of operation of driving operators, turning-on of a headlight, and operating of a wiper in addition to behavior information of the vehicle M such as a speed, acceleration, a yaw rate, a steering angle, position information, and route information of the vehicle M. The driving behavior information may include information on a situation in which the driving support function operates (is performed) (for example, an operating time or position and a type of the driving support function) or may include information such as information recognized by the recognizer in the vehicle system 100 (for example, the surrounding situation of the vehicle M), a camera image captured by a camera (an imager), and fellow passenger information. Information indicating the driving conditions of the driver D includes, for example, the surrounding environment (for example, the weather or the date and time, whether there is a nearby vehicle such as a preceding vehicle, whether there is construction, and whether there is an accident) of the vehicle M and biological information of the driver D at the time of driving. The information indicating the driving conditions of the driver D may include schedule information (scheduled behavior information) of the driver D. The vehicle M outputs information provided from the driving evaluation device 400 and notifies the driver or the like. The aforementioned processes in the vehicle M are performed by the vehicle system 100 mounted in the vehicle M.

The first terminal device 200 and the second terminal device 300 are, for example, smartphones or tablet terminals. The second terminal device 300 may be a general-purpose personal computer (PC). The first terminal device 200 may be connected to the vehicle M and serve as an onboard device. The first terminal device 200 transmits information input by the driver D to the driving evaluation device 400. The first terminal device 200 outputs information provided from the driving evaluation device 400 and notifies the driver D or the like.

The second terminal device 300 is used by a specific person P or the like correlated with the driver D in advance, acquires information from the driving evaluation device 400, and outputs the acquired information visually or auditorily to provide the information to the specific person P. The specific person P is, for example, a family member (a spouse or a parent and child) of the driver D, a person concerned for business (a superior, a subordinate, or a colleague), or a specific person concerned (that is, a person knowing the driver D) such as a lover or a friend.

The driving evaluation device 400 may be, for example, a server device or a general-purpose PC or may be a cloud server constituted by cloud computing including one or more information processing devices. The driving evaluation device 400 acquires and manages driving behavior information of drivers D transmitted from a plurality of vehicles M or evaluates driving behaviors of the drivers D. The driving evaluation device 400 transmits information on driving evaluation to the vehicles M, the first terminal devices 200, the second terminal devices 300, and the like and provides the information to the drivers D and the specific persons P. The functions of each vehicle M, each first terminal device 200, and the driving evaluation device 400 will be specifically described below. Since the second terminal devices 300 may employ the same functions as in the first terminal devices 200, a first terminal device 200 will be described below, and specific description of each second terminal device 300 will be omitted.

### [Vehicle]

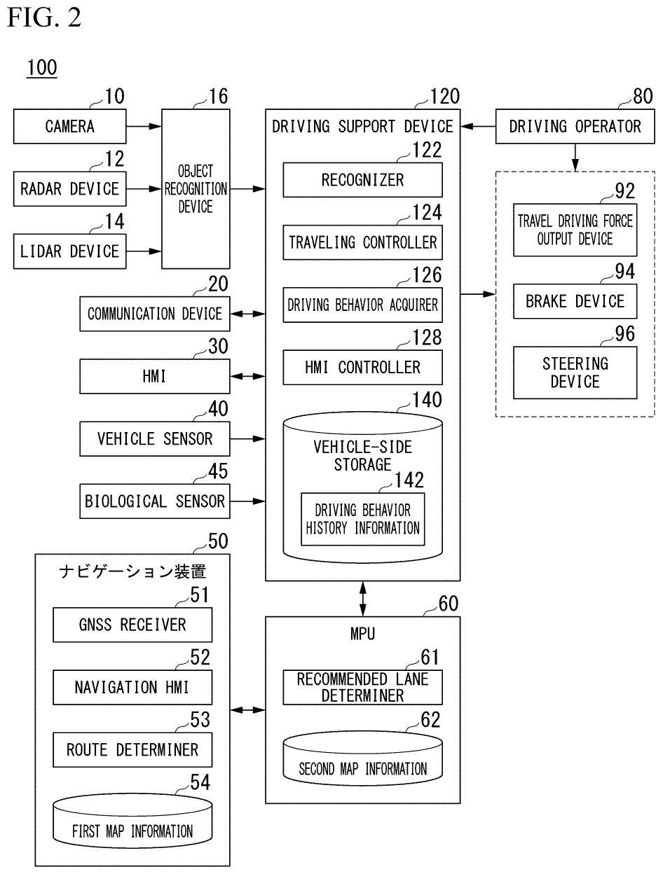

FIG. 2 is a diagram illustrating an example of a functional configuration of a vehicle system 100 that is mounted in a vehicle M. For example, the vehicle system 100 mounted in the vehicle M includes a camera 10, a radar device 12, a Light Detection and Ranging (LIDAR) device 14, an object recognition device 16, a communication device 20, a human-machine interface (HMI) 30, a vehicle sensor 40, a biological sensor 45, a navigation device 50, a map positioning unit (MPU) 60, a driving operator 80, a travel driving force output device 92, a brake device 94, a steering device 96, and a driving support device 120. These devices or instruments are connected to each other via a multiplex communication line such as a controller area network (CAN) communication line, a serial communication line, a radio communication network, or the like. The configuration illustrated in FIG. 2 is only an example and a part of the configuration may be omitted or another configuration may be added thereto.

The camera 10 is, for example, a digital camera using a solid-state imaging device such as a charge coupled device (CCD) or a complementary metal oxide semiconductor (CMOS). The camera 10 is attached to an arbitrary position on the vehicle M. When a forward view is imaged, the camera 10 is attached to an upper part of a front windshield, a rear surface of a rearview mirror, or the like. The camera 10 images the surroundings of the vehicle M, for example, periodically and repeatedly and acquires camera images. The camera 10 may be a stereo camera. The camera 10 may be, for example, a camera that is used for a drive recorder or the like for recording a video in an actual traveling situation.

The radar device 12 radiates radio waves such as millimeter waves to the surroundings of the vehicle M, detects radio waves (reflected waves) reflected by an object, and detects at least a position (a distance and a direction) of the object. The radar device 12 is attached to an arbitrary position on the vehicle M. The radar device 12 may detect a position and a speed of an object using a frequency modulated continuous wave (FM-CW) method.

The LIDAR device 14 radiates light (or electromagnetic waves of wavelengths close to light) to the surroundings of the vehicle M and measures scattered light. The LIDAR device 14 detects a distance to an object on the basis of a time from radiation of light to reception of light. The radiated light is, for example, a pulse-like laser beam. The LIDAR device 14 is attached to an arbitrary position on the vehicle M.

The object recognition device 16 performs a sensor fusion process on results of detection from some or all of the camera 10, the radar device 12, and the LIDAR device 14 and recognizes a position, a type, a speed, and the like of an object. The object recognition device 16 outputs the result of recognition to the driving support device 120. The object recognition device 16 may output the results of detection from the camera 10, the radar device 12, and the LIDAR device 14 to the driving support device 120 without any change. The object recognition device 16 may be omitted from the vehicle M.

The communication device 20 includes, for example, telematics control unit (TCU). The communication device 20 communicates with the driving evaluation device 400 or the driving evaluation device 400 or other vehicles near the vehicle M, for example, using a network NW such as a cellular network, a Wi-Fi network, Bluetooth, or dedicated short range communication (DSRC) or communicates with various other external devices. The communication device 20 may perform wireless communication with the first terminal device 200 of a driver D in the vehicle M via a short-range communication network such as a Wi-Fi network or Bluetooth or may perform wired communication with the first terminal device 200 by connection using a communication cable or the like. The communication device 20 may communicate with the second terminal device 300 via the network NW.

The HMI 30 presents various types of information to the driver D in the vehicle M and receives an input operation from the driver D. The HMI 30 includes, for example, a display device, a speaker, and a vibrator. The display device is, for example, a liquid crystal display (LCD) device or an organic electroluminescence (EL) display device. The display device is, for example, a display device called multi-information display that is provided at the center of an instrument penal of the vehicle M or in front of a driver's seat and displays various types of information on the vehicle M such as an operating status of the driving support function such as a speed meter (a speedometer) showing a traveling speed of the vehicle M or a rotational speed meter (a tachometer) showing the number of rotations (a rotational speed) of the internal combustion engine of the vehicle M. The speaker outputs a warning, message sound, speech, and the like. The vibrator gives vibration with predetermined strength to the driving operator 80 such as a driver's seat or a steering wheel to inform the driver D of a situation, an instruction, or the like. The HMI 30 may include, for example, buzzers, a touch panel, a microphone, and keys.

The vehicle sensor 40 includes a vehicle speed sensor that detects a speed of the vehicle M, an acceleration sensor that detects acceleration, a yaw rate sensor that detects an angular velocity around a vertical axis, and a steering angle sensor that detects a steering angle. The vehicle sensor 40 may include a position sensor that acquires a position of the vehicle M. The position sensor is, for example, a sensor that acquires position information (longitude and latitude information) of the vehicle M from a global positioning system (GPS) device. The position sensor may be a sensor that acquires the position information using a global navigation satellite system (GNSS) receiver 51 of the navigation device 50. The vehicle sensor 40 may include a weather sensor that predicts the weather near the vehicle M from the illuminance, the temperature, the humidity, the amount of rain, and the like near the vehicle M. Information detected by the vehicle sensor 40 is output to the driving support device 120.

The biological sensor 45 detects, for example, biological information such as a heart rate, a respiration rate, a body temperature, and a sweat rate of the driver D. The biological sensor may be a device that is installed in the steering wheel, the instrument panel, or the like of the vehicle M or may be a wearable device that is worn by the driver D to acquire biological information.

The navigation device 50 includes, for example, a GNSS receiver 51, a navigation HMI 52, and a route determiner 53. The navigation device 50 stores first map information 54 in a storage device such as a hard disk drive (HDD) or a flash memory. The GNSS receiver 51 identifies a position of the vehicle M on the basis of signals received from GNSS satellites. The position of the vehicle M may be identified or corrected by an inertial navigation system (INS) using the output of the vehicle sensor 40. The navigation HMI 52 includes a display device, a speaker, a touch panel, and keys. The navigation HMI 52 may be partially or wholly shared by the HMI 30. For example, the route determiner 53 determines a route (hereinafter referred to as a route on a map) from the position of the vehicle M identified by the GNSS receiver 51 (or an input arbitrary position) to a destination input by the driver D using the navigation HMI 52 with reference to the first map information 54. The first map information 54 is, for example, information in which a road shape is expressed by links indicating a road and nodes connected by the links. The first map information 54 may include a curvature or a gradient of a road or point of interest (POI) information. The route on a map is output to the MPU 60. The navigation device 50 may perform route guidance using the navigation HMI 52 on the basis of the route on a map. The navigation device 50 may be realized, for example, by a function of the first terminal device 200 of the driver D. The navigation device 50 may transmit a current location and a destination to a navigation server via the communication device 20 and acquire a route equivalent to the route on a map from the navigation server.

The MPU 60 includes, for example, a recommended lane determiner 61 and stores second map information 62 in a storage device such as an HDD or a flash memory. The recommended lane determiner 61 divides the route on a map provided from the navigation device 50 into a plurality of blocks (for example, blocks every 100 [m] in a vehicle traveling direction) and determines a recommended lane for each block with reference to the second map information 62. The recommended lane determiner 61 determines in which lane from the leftmost the vehicle M is to travel. When there is a branching point in the route on a map, the recommended lane determiner 61 determines the recommended lane such that the vehicle M can travel along a rational route for traveling to a branching destination. The second map information 62 is map information with higher precision than the first map information 54. For example, the second map information 62 includes information of centers of lanes and information of boundaries of lanes (road marking lines). The second map information 62 may include road information such as the number of lanes or road widths (widths) of a road, traffic regulation information (such as speed limits of the road and temporary stop positions), road signs, address information (addresses and postal codes), facility information, and phone number information. The second map information 62 may be updated from time to time by causing the communication device 20 to communicate with another device.

The driving operator 80 includes, for example, a steering wheel, an accelerator pedal, a brake pedal, a shift lever, an operation switch of a direction indicator, and other operators. A sensor that detects an amount of operation or whether an operation has been performed is attached to the driving operator 80. Results of detection of the sensor are output to the driving support device 120 or output to some or all of the travel driving force output device 92, the brake device 94, and the steering device 96.

The travel driving force output device 92 outputs a travel driving force (a torque) for allowing the vehicle to travel to driving wheels. The travel driving force output device 92 includes, for example, a combination of an internal combustion engine, an electric motor, and a transmission and an electronic control unit (ECU) that controls them. The ECU controls the aforementioned constituents on the basis of information input from the driving support device 120 or information input from the driving operator 80.

The brake device 94 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of the information input from the driving support device 120 or the information input from the driving operator 80 such that a brake torque based on a brake operation is output to vehicle wheels. The brake device 94 may include a mechanism for transmitting a hydraulic pressure generated by an operation of the brake pedal included in the driving operator 80 to the cylinder via a master cylinder as a backup. The brake device 94 is not limited to the above-mentioned configuration and may be an electronically controlled hydraulic brake device that controls an actuator on the basis of information input from the driving support device 120 such that the hydraulic pressure of the master cylinder is transmitted to the cylinder.

The steering device 96 includes, for example, a steering ECU and an electric motor. The electric motor changes a direction of turning wheels, for example, by applying a force to a rack-and-pinion mechanism. The steering ECU drives the electric motor to change the direction of the turning wheels on the basis of the information input from the driving support device 120 or the information input from the driving operator 80. The steering device 96 may include a steering reaction mechanism for curbing a steering operation of the driver D by applying a predetermined reaction force such that the steering wheel rotates in a reverse direction of a steering direction of the steering wheel operated by the driver D (such that the steering wheel is less likely to rotate in a steering direction) under the control of the driving support device 120.

The driving support device 120 includes, for example, a recognizer 122, a traveling controller 124, a driving behavior acquirer 126, an HMI controller 128, and a vehicle-side storage 140. Some or all of the recognizer 122, the traveling controller 124, the driving behavior acquirer 126, and the HMI controller 128 are realized, for example, by causing a hardware processor such as a central processing unit (CPU) to execute a program (software). Some or all of these constituents may be realized by hardware (a circuit part including circuitry) such as a large scale integration (LSI) device, an application-specific integrated circuit (ASIC), or a field-programmable gate array (FPGA), a graphics processing unit (GPU), or a system on chip (SOC) or may be cooperatively realized by software and hardware. The program may be stored in a storage device (a storage device including a non-transitory storage medium) such as an HDD or a flash memory of the driving support device 120 in advance or may be stored in a removable storage medium such as a DVD or a CD-ROM and installed in the HDD or the flash memory of the driving support device 120 by setting the removable storage medium (a non-transitory storage medium) into a drive device.

The vehicle-side storage 140 is realized, for example, by an HDD, a flash memory, an electrically erasable programmable read only memory (EEPROM), a read only memory (ROM), a random access memory (RAM), or the like. For example, driving behavior history information 142, programs, and various types of other information are stored in the vehicle-side storage 140. The driving behavior history information 142 is information that is acquired or generated by the driving behavior acquirer 126 and includes driving behavior information.

The recognizer 122 recognizes a surrounding situation of the vehicle M on the basis of information input from the camera 10, the radar device 12, and the LIDAR device 14 via the object recognition device 16. For example, the recognizer 122 recognizes states such as a position (a position relative to the vehicle M), a speed (a speed relative to the vehicle M), and an acceleration of an object (for example, another vehicle, a pedestrian, or a road structure) near the vehicle M (for example, within a predetermined distance from the vehicle M) on the basis of the input information. For example, a position of an object is recognized as a position in an absolute coordinate system with a representative point (such as the center of gravity or the center of a drive shaft) of the vehicle M as an origin and is used for control. A position of an object may be expressed as a representative point such as the center of gravity or a corner of the object or may be expressed as an area. A “state” of an object may include an acceleration or a jerk of the object or a “moving state” (for example, whether lane change is being performed or whether lane change is going to be performed) thereof.

The recognizer 122 recognizes, for example, a lane (a traveling lane) in which the vehicle M is traveling. For example, the recognizer 122 recognizes the traveling lane by comparing a pattern of road marking lines near the vehicle M recognized from the camera image of the camera with a pattern of road marking lines acquired from the second map information 62 (for example, arrangement of solid lines and dotted lines). The recognizer 122 is not limited to the road marking lines, but may recognize the traveling lane by recognizing traveling lane boundaries (road boundaries) including edges of roadsides, curbstones, median strips, and guard rails. In this recognition, the position of the vehicle M acquired from the navigation device 50 or the result of processing from the INS may be considered. The recognizer 122 recognizes a temporary stop line, an obstacle, a red signal, a toll gate, or other road events. The recognizer 122 may recognize the number of nearby lanes or road signs on the basis of the analysis result of the camera images and the map information.

The recognizer 122 recognizes a position or a posture of the vehicle M with respect to the traveling lane at the time of recognition of the traveling lane. The recognizer 122 may recognize, for example, a degree of separation of a reference point (for example, the center of gravity or the center) of the vehicle M from the lane center and an angle of the traveling direction of the vehicle M with respect to a line formed by connecting the lane centers as the position and the posture of the vehicle M with respect to the traveling lane. Instead, the recognizer 122 may recognize a position of a reference point of the vehicle M with respect to one side line of the traveling lane (a road marking line or a road boundary) or the like as the relative position of the vehicle M with respect to the traveling lane.

The recognizer 122 may analyze the camera images captured by the camera 10 through a known image analysis process and recognize the surrounding environment such as the weather (for example, snowfall or rainfall) near the vehicle M or whether there is a construction or an accident in the traveling direction of the vehicle M. The recognizer 122 may recognize conditions of the driver D (for example, anxious, angry, or drowsy) or the like on the basis of the biological information detected by the biological sensor 45. The recognizer 122 may recognize information of a fellow passenger who is in the vehicle M along with the driver D. The fellow passenger information includes, for example, identification information of the fellow passenger (such as personal information) or information indicating a relation to the driver D. The fellow passenger information may be input by the HMI 30 or may be acquired through inputting using the first terminal device 200.

The traveling controller 124 activates a driving support function satisfying predetermined operating conditions out of driving support functions (such as an RDM, an FCW, and a CMBS) which can be performed (activated) by the vehicle M on the basis of the surrounding situation recognized by the recognizer 122 when the driver D performs manual driving using the driving operator 80. For example, when the driving support function corresponding to the surrounding situation is activated, the traveling controller 124 displays an image or outputs sound or issues a predetermined alarm using vibration, steering reaction, or the like to attract attention of the driver D. When displaying of an image or outputting of sound is performed through the driving support function, the traveling controller 124 causes the HMI controller 128 to output a predetermined image or sound from the HMI 30. When the steering wheel or the driver's seat is caused to vibrate, the traveling controller 124 controls the vibrator 36 such that predetermined vibration is output. When steering reaction is performed, the traveling controller 124 controls a steering reaction mechanism of the steering device 96 such that a steering reaction force is applied in a predetermined direction.

When the driving support function is activated, the traveling controller 124 may generate a target trajectory such that the vehicle M travels along a recommended lane determined by the MPU 60 without coming into contact with a nearby object and control at least one of the travel driving force output device 92, the brake device 94, and the steering device 96 such that the vehicle M travels along the generated target trajectory. Accordingly, one or both of steering and a speed of the vehicle M are controlled, and automated driving of the vehicle M suitable for the purpose is performed.

The driving behavior acquirer 126 acquires information such as information input by the HMI 30, detection results from the vehicle sensor 40 or the biological sensor 45, information acquired by the navigation device 50, a detection result (an amount of operation) from a sensor provided in the driving operator 80, a recognition result from the recognizer 122, and control details from the traveling controller 124 (an operation result of the driving support function). The driving behavior acquirer 126 may acquire various types of information (for example, input information from the driver D, position information, the speed, and acceleration information detected by the sensor or the like) from the first terminal device 200 of the driver D via the communication device 20. The driving behavior acquirer 126 generates driving behavior information on the basis of the acquired information. The driving behavior acquirer 126 stores the generated driving behavior information as the driving behavior history information 142 in the vehicle-side storage 140 in correlation with date and time information of input, detection, or control. The driving behavior acquirer 126 transmits the driving behavior history information 142 to the driving evaluation device 400 at a predetermined timing (for example, at the timing of driving end or in a predetermined period). The driving behavior acquirer 126 may add identification information (for example, a vehicle ID) for identifying the vehicle M or identification information (for example, a driver ID) for identifying the driver D to the transmitted information.

The HMI controller 128 notifies the driver D of the vehicle M of predetermined information via the HMI 30 or acquires operation details of the driver D received via the HMI 30. The predetermined information includes, for example, information associated with traveling of the vehicle M such as information on the state of the vehicle M or information on the driving support function during operation. The information on the state of the vehicle M includes, for example, information such as a speed, an engine rotation speed, and a shift position of the vehicle M. The information on driving control may include, for example, information indicating what driving support function is operating. The predetermined information includes evaluation results of a driving behavior of the driver D provided from the driving evaluation device 400 or the like. The predetermined information may include information not associated with traveling control of the vehicle M such as television programs and contents (for example, movies) stored in a storage medium such as a DVD.

For example, the HMI controller 128 may generate an image (which may be a still image or a moving image) including the predetermined information and display the generated image on the display device of the HMI 30, or may generate sound indicating predetermined information and cause the speaker of the HMI 30 to output the generated sound.

### [First Terminal Device]

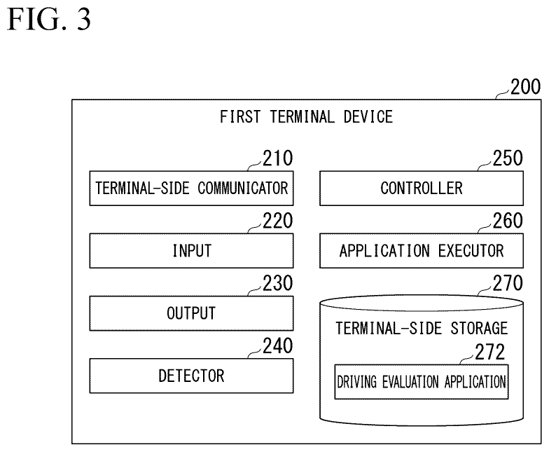

FIG. 3 is a diagram illustrating an example of a functional configuration of a first terminal device 200. The first terminal device 200 includes, for example, a terminal-side communicator 210, an input 220, an output 230, a detector 240, a controller 250, an application executor 260, and a terminal-side storage 270. Some or all of the controller 250 and the application executor 260 are realized, for example, by causing a hardware processor such as a CPU to execute a program (software). Some or all of these constituents may be realized by hardware (a circuit part including circuitry) such as an LSI device, an ASIC, an FPGA, a GPU, or an SOC or may be cooperatively realized by software and hardware. The program may be stored in a storage device (a storage device including a non-transitory storage medium) such as an HDD or a flash memory in advance or may be stored in a removable storage medium (a non-transitory storage medium) such as a DVD or a CD-ROM and installed in the storage device by setting the removable storage medium into a drive device or a card slot of the first terminal device 200.

The terminal-side storage 270 may be realized by the aforementioned various storage devices, an EEPROM, a ROM, a RAM, or the like. For example, a driving evaluation application 272, programs, and various types of other information are stored in the terminal-side storage 270.

The terminal-side communicator 210 communicates with the driving evaluation device 400 and other external devices, for example, via the network NW. The terminal-side communicator 210 may communicate with the vehicle M via a short-range communication network or the network NW.

The input 220 receives, for example, an input of the driver D based on an operation on various keys or buttons. The input 220 may include a microphone for receiving an auditory input of the driver D. For example, the input 220 receives an input of a use request of a service provided by the driving evaluation device 400, driver information, and response information to an inquiry about whether to curb the driving support function.

The output 230 includes, for example, a display and a speaker and outputs predetermined information to the display or the speaker. The display is, for example, an LCD or an organic EL display. The input 220 may be unified with the display as a touch panel. The display displays an image based on various types of information. The speaker outputs predetermined sound. For example, the output 230 outputs information such as an image or sound corresponding to information provided by the driving evaluation device 400 or outputs information input from the input 220.

The detector 240 detects various types of information on the first terminal device 200. For example, the detector 240 includes a position sensor, a speed sensor, or an acceleration sensor. The position sensor detects the position of the first terminal device 200 via the GPS device similarly to the position sensor provided in the vehicle sensor. The speed sensor detects the speed of the first terminal device 200 from a moving distance (displacement of the position information) in a predetermined time. The acceleration sensor detects the acceleration of the first terminal device 200.

The controller 250 controls all functions of the first terminal device 200. For example, the controller 250 performs communication control using the terminal-side communicator 210, input/output control using the input 220 and the output 230, and execution control of the driving evaluation application 272 using the application executor 260.

The application executor 260 is realized by executing the driving evaluation application 272 stored in the terminal-side storage 270. For example, the driving evaluation application 272 is downloaded from an external device via the network NW and is installed in the first terminal device 200. The driving evaluation application 272 is application software that acquires information on driving evaluation of the driver D of the vehicle M from the driving evaluation device 400 and outputs the acquired information to the output 230. The driving evaluation application 272 transmits information input from the input 220 to the driving evaluation device 400 or transmits information detected by the detector 240 to the vehicle M or the driving evaluation device 400. Identification information (for example, a terminal ID) for identifying the first terminal device 200 or a driver ID may be added to the transmitted information.

In the functional configuration of a second terminal device 300, the “first terminal device 200” in description of the functional configuration of the first terminal device 200 is replaced with the “second terminal device 300,” and the “driver D” is replaced with a “specific person P.” The configuration of the second terminal device 300 may not include the detector 240 and may not transmit a detection result from the detector 240.

### [Driving Evaluation Device]

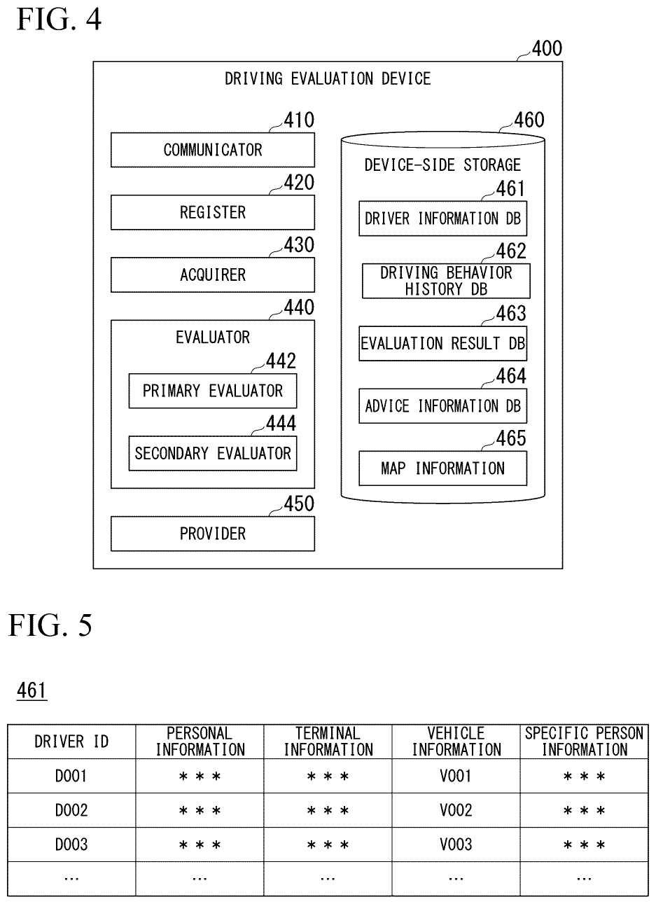

FIG. 4 is a diagram illustrating an example of a functional configuration of the driving evaluation device 400. The driving evaluation device 400 includes, for example, a communicator 410, a register 420, an acquirer 430, an evaluator 440, a provider 450, and a device-side storage 460. Some or all of the register 420, the acquirer 430, the evaluator 440, and the provider 450 are realized, for example, by causing a hardware processor such as a CPU to execute a program (software). Some or all of these constituents may be realized by hardware (a circuit part including circuitry) such as an LSI device, an ASIC, an FPGA, a GPU, or an SOC or may be cooperatively realized by software and hardware. The program may be stored in a storage device (a storage device including a non-transitory storage medium) such as an HDD or a flash memory in advance or may be stored in a removable storage medium (a non-transitory storage medium) such as a DVD or a CD-ROM and installed in the storage device by setting the removable storage medium into a drive device of the driving evaluation device 400. The driving evaluation device 400 may be realized by allowing a provider of a driving support function providing service to install a program in a cloud server. In this case, an owner of hardware of the driving evaluation device 400 may be different from the provider of the service.

The device-side storage 460 may be realized by the aforementioned various storage devices, an EEPROM, a ROM, a RAM, or the like. For example, a driver information database (DB) 461, a driving behavior history DB 462, an evaluation result DB 463, an advice information DB 464, map information 465, programs, and various types of other information are stored in the device-side storage 460. At least a part of information stored in the device-side storage 460 may be stored in an external device (for example, a DB server) that can communicate with the driving evaluation device 400.

FIG. 5 is a diagram illustrating an example of details of the driver information DB 461. The driver information DB 461 is, for example, information in which personal information, terminal information, vehicle information, and specific person information are correlated with a driver ID. The personal information includes, for example, information such as name, age, sex, address, and contact information. The personal information may include a social score. The social score is obtained, for example, by scoring an influence on social media such as a social networking service (SNS) and is used as an index for planning an influence, reliability, an advertisement effect, or the like on an account (a viewer). The terminal information is identification information (for example, a terminal ID) for identifying the first terminal device 200 used by the driver D. The personal information may include incentive information given to the driver D. The terminal information may include address information for allowing the driving evaluation device 400 to communicate with the first terminal device 200. The vehicle information is, for example, identification information (for example, a vehicle ID) of the vehicle driven by the driver D. The vehicle information may include address information for allowing the driving evaluation device 400 to communicate with the vehicle M. The specific person information includes information on a specific person P which is correlated with the driver D and on which secondary driving evaluation which will be described later can be performed by the evaluator 440. The information on a specific person P includes personal information of the specific person P, information (or example, a spouse, a parent and child, a lover, a friend, a senior, a subordinate, or a companion) indicating a relation between the driver D and the specific person P, and information (for example, a terminal ID or address information for communicating with the second terminal device 300) on the second terminal device 300 used by the specific person P. The specific person information may include the number of times or the frequency of second driving evaluation for each specific person P and incentive information given according to details. Data stored in the driver information DB 461 is generated, for example, on the basis of information acquired by the register 420 or the acquirer 430.

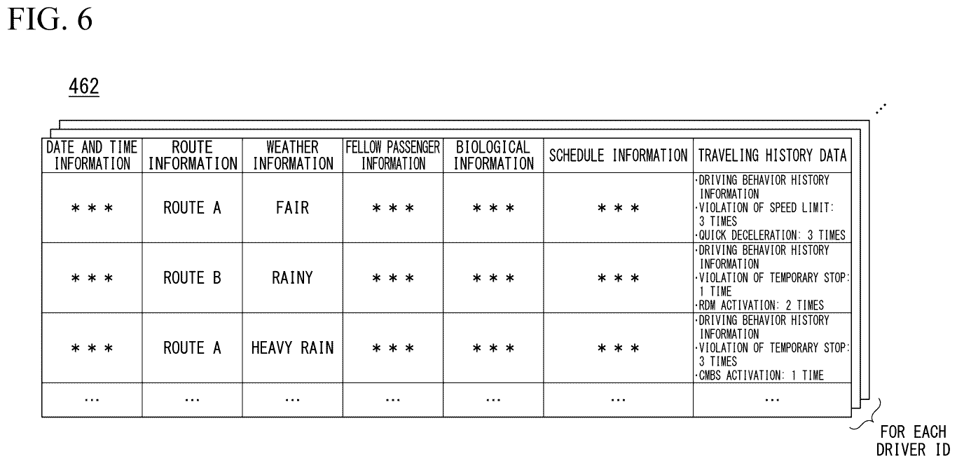

FIG. 6 is a diagram illustrating an example of details of the driving behavior history DB 462. The driving behavior history DB 462 includes information (driving data) on driving of the vehicle M by the driver D. For example, in the driving behavior history DB 462, date and time information, route information, weather information, fellow passenger information, biological information, schedule information, and traveling history data are correlated. This information is stored, for example, for each driver ID. The date and time information is information on a date and time (for example, a driving start date and time and a driving end date and time) at which the driver D has driven the vehicle M. The route information includes, for example, information on a route along which the vehicle M has traveled. The information on a route includes information indicating at what time the vehicle has passed through positions on the route. The weather information includes weather information corresponding to the date and time information and the route information. The weather information corresponding to the date and time information and the route information may be acquired, for example, from an external device via the network NW. The fellow passenger information includes, for example, information on a fellow passenger who is in the vehicle M along with the driver D when the vehicle M is traveling.

The biological information includes, for example, biological information of the driver D detected by the biological sensor 45 of the vehicle M. The schedule information includes, for example, schedule information in a predetermined period before and after the driver D performs driving which is acquired from the vehicle M or the first terminal device 200 and schedule information in a predetermined period before and after the driver D performs driving which is registered in the driving evaluation device 400. The traveling history data includes, for example, history data of traveling information of the vehicle M. The traveling history data includes information on the driving behavior history information 142 acquired from the vehicle M. The traveling history data may include information on the number of times an unsafe driving operation has been performed (for example, speed limit violation, sudden acceleration, quick deceleration, or temporary stop violation) or the number of times a predetermined driving support function (for example, the RDM, the FCW, or the CMBS) has been performed by the traveling controller 124 while traveling along the route. Data stored in the driving behavior history DB 462 is generated, for example, on the basis of information acquired by the acquirer 430. At least a part of information stored in the driver information DB 461 and the driving behavior history DB 462 may be generated from the driving behavior history information 142 transmitted from the vehicle M.

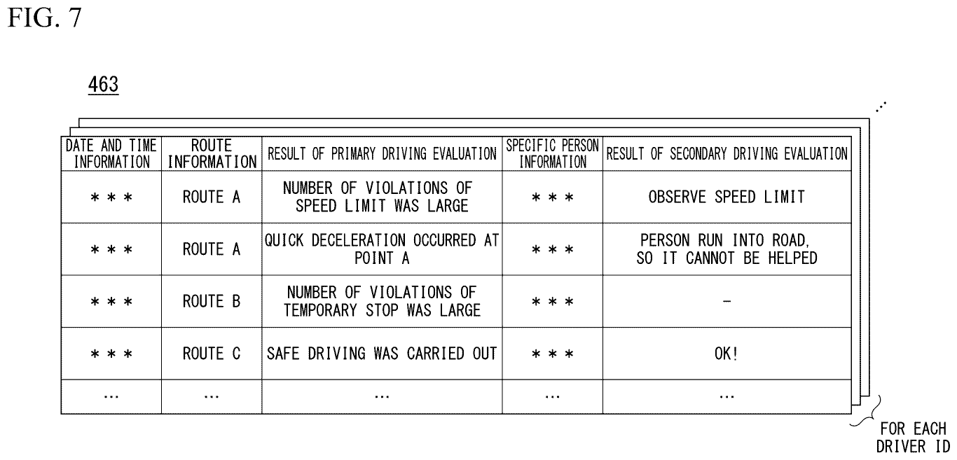

FIG. 7 is a diagram illustrating an example of details of the evaluation result DB 463. In the evaluation result DB 463, for example, date and time information, route information, a primary driving evaluation result, specific person information, and a secondary driving evaluation result are correlated. This information is stored, for example, for each driver ID. The primary driving evaluation result and the secondary driving evaluation result are information acquired by the evaluator 440. The specific person information is information on a specific person who has performed secondary driving evaluation. Data stored in the evaluation result DB 463 is generated, for example, by the evaluator 440.

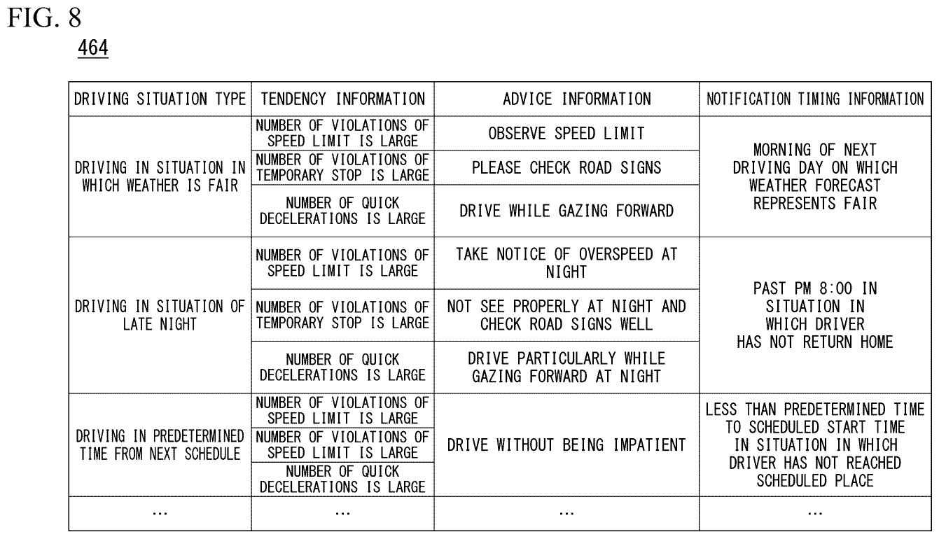

FIG. 8 is a diagram illustrating an example of details of the advice information DB 464. The advice information DB 464 is information in which advice information and notification timing information are correlated with a driving situation type and tendency information. The driving situation type is, for example, information for identifying a scene or a situation in which the driver D drives the vehicle M. The tendency information is, for example, information indicating what driving tendency the driver D has. The advice information is, for example, driving advice information (for example, coaching information such as precautions) on the driver corresponding to the driving situation type and the tendency information. The notification timing information is information on a timing at which the driver D is notified of advice information. The advice information DB 464 may be predetermined information or may be appropriately updated.

The map information 465 may be the same map information as the aforementioned map information (the first map information 54 and the second map information 62) or may be map information with higher precision and a broader range.

Referring back to FIG. 4, the communicator 410 communicates with the vehicle M, the first terminal device 200, the second terminal device 300, and other external devices via the network NW.

The register 420 performs a process of registering a driver who uses the driving evaluation system 1. For example, the register 420 registers driver information in the driver information DB 461 on the basis of a registration request from the vehicle M or the first terminal device 200. In this case, the register 420 generates an image for allowing the driver D to input the details (for example, personal information, terminal information, vehicle information, and specific person information) included in the driver information DB 461 in response to the registration request and transmits the generated image to the vehicle M or the first terminal device 200. The register 420 may receive information on a traveling route which is used daily by the driver D from the vehicle M or the first terminal device 200 and register the received information as a target route for driving evaluation.

The register 420 registers information input by the driver D as driver information in the driver information DB 461 along with the driver ID. The register 420 may receive an update request for driver information registered in advance in the driver information DB 461 from the vehicle M or the first terminal device 200 and update the target driver information.

The acquirer 430 acquires driving behavior information of the driver D of the vehicle M. For example, the acquirer 430 acquires various types of information from the vehicle M, the first terminal device 200, the second terminal device 300, and an external device connected thereto via the network NW on the basis of information received by the communicator 410. For example, the acquirer 430 acquires the driving behavior history information 142 from the vehicle M, extracts a part from the acquired information, and generates information corresponding to the details (date and time information, route information, weather information, fellow passenger information, biological information, and schedule information) of the driving behavior history DB 462. At least a part of the information included in the driving behavior history information 142 may be acquired from the first terminal device 200. The acquirer 430 generates remaining information other than the aforementioned partial information in the driving behavior history information 142 as traveling history data. The acquirer 430 registers the generated various types of information in the driving behavior history DB 462 for each driver ID. The traveling history data may include details processed by the evaluator 440.

The acquirer 430 may acquire the advice information DB 464 from an external device or the like via the network NW and store the acquired advice information DB 464 in the device-side storage 460.

The evaluator 440 evaluates a driving behavior of the driver D for the vehicle M. For example, the evaluator 440 includes a primary evaluator 442 and a secondary evaluator 444. The primary evaluator 442 performs primary driving evaluation for evaluating the driving behavior of the driver D on the basis of the information (for example, the driving behavior information) acquired by the acquirer 430. For example, the primary evaluator 442 quantitatively analyzes the traveling behavior on a predetermined driving route (for example, a moving route which is used daily and registered in advance) and performs primary driving evaluation based on the analysis result. For example, the quantitative analysis is to analyze the number of times or the frequency a predetermined driving behavior (speed limit violation, sudden acceleration, quick deceleration, temporary stop violation, RDM activation, or CMBS activation) has been performed during driving, but is not limited thereto.

The primary evaluator 442 estimates a factor causing change of evaluation of the driving behavior on the basis of the quantitative analysis result. For example, the primary evaluator 442 estimates a factor causing change of evaluation of the driving behavior (for example, an external factor based on the surrounding environment or an internal factor based on the driver) on the basis of the quantitative analysis result, the surrounding environment when the vehicle M is driven (for example, time information, weather, whether there is a nearby vehicle, whether there is an accident, or whether there is a construction during driving), the driving conditions of the driver D (for example, anxious or drowsy), and the schedule information of the driver D. Then, the primary evaluator 442 determines at least one of details of driving advice for the driver D and a timing at which the driver D is notified of (provided with) the driving advice on the basis of the estimation result.

The secondary evaluator 444 performs secondary driving evaluation for allowing a specific person P to evaluate the driving behavior of the driver D on the basis of the primary driving evaluation result. Here, the specific person P may be one or more specific persons included in the specific person information registered in advance in the driver information DB 461 or may be a specific person P set (selected) by the driver D out of the one or more specific persons. By allowing the driver D to select a desired specific person P, it is possible to obtain an evaluation result with high agreement or high acceptability of the driver D. The specific person P may be a fellow passenger. The fellow passenger feels the driving behavior of the driver D and thus can perform more accurate driving evaluation. The specific person P may be a specific person P which is randomly set out of one or more specific persons. The specific person P is, for example, a specific person concerned such as an acquaintance of the driver D and is a person other than an event provider providing a driving evaluation service on the basis of a traveling history. The specific person P may be set by the driver D before starting driving or may be set while driving or after ending driving. A plurality of specific persons P may be selected by the driver D. For example, when a plurality of specific persons are selected, the secondary evaluator 444 averages the evaluation results and generates a secondary driving evaluation result.

For example, the secondary evaluator 444 transmits information on the primary driving evaluation result from the primary evaluator 442 to the second terminal device 300 of the specific person P via the communicator 410. The information on the primary driving evaluation result may include information such as a camera image, position information, route information, a surrounding environment, and driver conditions at the time of driving corresponding to the primary driving evaluation result in addition to the primary driving evaluation result. Accordingly, the specific person P can perform more appropriate driving evaluation using various types of information. Information such as an image provided to the second terminal device 300 may be generated by the provider 450 or the like. The secondary evaluator 444 acquires information (for example, the secondary driving evaluation result and transmission permission information of the evaluation result) from the specific person P using the second terminal device 300. The evaluation results (the primary driving evaluation result and the secondary driving evaluation result) acquired by the evaluator 440 is stored in the evaluation result DB 463. The secondary evaluator 444 may not be able to acquire a secondary driving evaluation result from the specific person P even when the secondary driving evaluation is performed. Details of the function of the evaluator 440 will be described later.

The provider 450 generates various types of information (for example, an image or sound) processed by the register 420, the acquirer 430, and the evaluator 440 and transmits the generated information to the vehicle M, the first terminal device 200, the second terminal device 300, and the like such that the information is provided to the driver D or the specific person P. For example, the provider 450 provides the evaluation result from the evaluator 440 to at least one of the vehicle M and the first terminal device 200 used by the driver D. For example, the provider 450 provides the evaluation result (for example, the primary driving evaluation result) from the evaluator 440 to at least one of the vehicle M and the first terminal device 200 via the second terminal device 300 used by the specific person P correlated with the driver D. When the evaluation result includes the primary driving evaluation result and the secondary driving evaluation result, the provider 450 may provide at least one of the primary driving evaluation result and the secondary driving evaluation result to at least one of the vehicle M and the first terminal device 200 on the basis of a request from the driver D. The provider 450 may provide driving advice information which the driver D is notified of.

### [Evaluator]

Details of the function of the evaluator 440 will be described below. For example, on the basis of speed information or acceleration information of the vehicle M included in the driving behavior information, the primary evaluator 442 evaluates that sudden acceleration is being performed when an increase in seed in a predetermined time is equal to or greater than a first threshold value and evaluates that quick deceleration is being performed when a decrease in speed is equal to or greater than a second threshold value. The primary evaluator 442 acquires a speed and position information of the vehicle M every predetermined time included in the driving behavior information and acquires traffic regulation information (a speed limit, a temporary stop position, and the like) of a road on which the vehicle M is traveling with reference to the map information 465 on the basis of the position information. For example, when the speed of the vehicle M is higher by a predetermined speed or more than the speed limit, the primary evaluator 442 evaluates that a speed limit is violated. When the speed of the vehicle M in the vicinity of the temporary stop position is not zero (0) (when the vehicle does not stop), the primary evaluator 442 evaluates that the temporary stop is violated.

The primary evaluator 442 acquires the number of times evaluation has been performed for each of the aforementioned evaluation details in a predetermined route (for example, a traveling route which is used daily). The primary evaluator 442 may acquire the number of times the driving support function mounted in the vehicle M has been activated in the predetermined route.

The primary evaluator 442 compares the acquired number of times with a reference number of times set for each evaluation details in advance and evaluates the frequency of the driving behavior according to whether the acquired number of times is equal to or greater than the reference number of times. For example, the primary evaluator 442 evaluates that the speed limit has been violated many when the number of times the speed limit has been violated is equal to or greater than a reference number of times and evaluates the speed limit has been violated few (or that driving is safe) when the number of times is less than the reference number of times. The primary evaluator 442 may change evaluation details according to a difference from the reference number of times (for example, very many or very few). The reference number of times may be changed according to the surrounding environment of the vehicle M or the conditions of the driver D during driving. Accordingly, it is possible to obtain a more appropriate primary driving evaluation result.

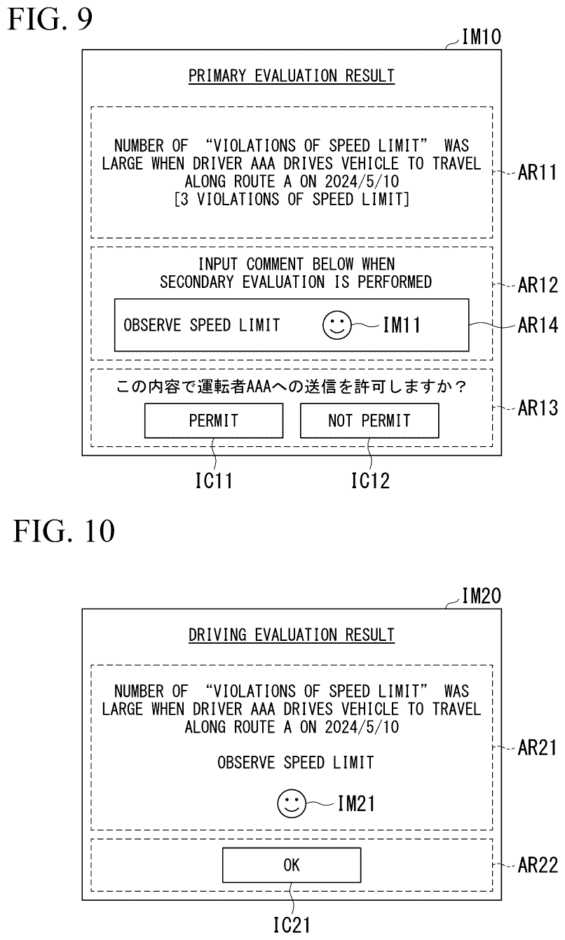

The secondary evaluator 444 causes the provider 450 to generate an image including information on the primary driving evaluation result from the primary evaluator 442 and transmits the generated image to the second terminal device 300 of the specific person P via the communicator 410. The secondary evaluator 444 may cause the provider 450 to generate sound based on details displayed in the image and transmit the sound to the second terminal device 300. FIG. 9 is a diagram illustrating an example of an image IM10 including information on a primary driving evaluation result. A display mode of a layout or display details, or the lime of the image IM10 is not limited to the example illustrated in FIG. 9. The same is true of an image IM20 illustrated in FIG. 10 which will be described later.

The image IM10 includes a primary evaluation result display area AR11, a secondary evaluation input area AR12, and a switch display area AR13. For example, information on the driver D evaluated by the primary evaluator 442, a driving date and time of evaluation (which may be only a date or only a time), route information, and information on the primary driving evaluation result (which may include number-of-times information) are displayed in the primary evaluation result display area AR11. In addition to the information, a camera image or a surrounding environment during driving subjected to primary evaluation and information on the conditions of the driver D may be displayed in the primary evaluation result display area AR11.

Information for inquiring about whether the specific person P is to perform secondary driving evaluation based on temporary evaluation and an input area AR14 for inputting a secondary driving evaluation result are displayed in the secondary evaluation input area AR12. In addition to character information (text information), image information IM11 such as a pictograph or a stamp image may be able to be input to the input area AR14.

The switch display area AR13 includes, for example, information for inquiring about whether the primary driving evaluation result (which includes a secondary driving evaluation result when the secondary driving evaluation result is input) is permitted to be transmitted to the driver D in the displayed details, an icon IC11 for receiving permission of transmission, and an icon IC12 for receiving non-permission of transmission (or postponement of transmission for a predetermined time). The icons IC11 and IC12 are, for example, graphical user interface (GUI) switches. For example, when selection of the icon IC11 has been received from the specific person P, the second terminal device 300 transmits the information input to the input area AR14 and the information indicating that the specific person P has permitted transmission to the driving evaluation device 400 and ends displaying of the image IM10. When selection of the icon IC12 has been received from the specific person P, the second terminal device 300 transmits the information indicating that the specific person P has not permitted transmission to the driving evaluation device 400 and ends displaying of the image IM1. The second terminal device 300 may transmit information input to the input area AR14 after the transmission has been postponed for a time instead of the information indicating that the specific person P has not permitted transmission. In this case, the second terminal device 300 may determine that the specific person P has operated the icon IC12 to express an intention of temporary postponement, re-display information for inquiring about whether the transmission is to be permitted after a predetermined time to select whether the transmission is to be permitted again, and then ascertain an intention of the specific person P or may automatically transmit the information after a predetermined time elapses. Accordingly, it is possible to obtain a side effect of reducing an operating burden on the specific person P performing secondary evaluation. By adding the function of postponing the transmission for a predetermined time, it is possible to enable the specific person P to evaluate the driver D at an arbitrary timing or to ascertain or correct evaluation details before the transmission, and thus it is possible to sufficiently consider an operating environment of the specific person P.

When selection of the icon IC11 is received, the provider 450 may generate an image for inquiring of the specific person P about information on the timing of notification, transmit the generated image to the second terminal device 300, and acquire information on the timing of notification.

The evaluator 440 stores the primary driving evaluation result and the secondary driving evaluation result in the evaluation result DB 463 in correlation with the date and time information, the route information, and information of the specific person having performed the secondary driving evaluation.

The provider 450 generates an image including information on the evaluation result (for example, at least one of the primary driving evaluation result and the secondary driving evaluation result selected by the driver D) from the evaluator 440 and provides the driving evaluation result to at least one selected by the driver D out of the vehicle M and the first terminal device 200 to notify the driver D. The provider 450 may generate sound based on details displayed in the image and transmit the generated sound to the second terminal device 300. The timing at which the driving evaluation result is transmitted may be set by the specific person P using the second terminal device 300 or may be set by the driver D.

FIG. 10 is a diagram illustrating an example of an image IM20 including information on a driving evaluation result which the driver D is notified of The image IM20 includes an evaluation result display area AR21 and a switch display area AR22. For example, driving evaluation information acquired by the primary evaluator 442 or the secondary evaluator 444 is displayed in the evaluation result display area AR21. A primary driving evaluation result and a secondary driving evaluation result are displayed in the evaluation result display area AR21 illustrated in FIG. 10. In the evaluation result display area AR21, image information IM21 such as a pictograph or a stamp image may be displayed or advice information which will be described later may be displayed.

For example, an icon IC21 for receiving end of displaying of the image IM20 from the driver D is included in the switch display area AR22. When selection of the icon IC21 is received, the first terminal device 200 ends displaying of the image IM20.

In this way, according to the embodiment, the driver D can be notified of the driving evaluation result ascertained by the specific person P at the timing designated by the specific person P. Accordingly, when the specific person P is a family member living together with the driver D, the specific person P can ascertain current conditions (states) of the driver D and transmit the driving evaluation result when the driver D has stable conditions. Since the specific person P is assumed to be a person who well knows a personality, a life pattern, or the like of the driver D, the specific person P can notify the driver D of the evaluation result at a timing at which the driver D does not feel unpleasant. Accordingly, it is possible to further improve agreement or acceptability of the driver D with respect to the driving evaluation. As a result, it is possible to enhance continuous usability of the driving evaluation system 1.

The primary evaluator 442 may collect and quantitatively analyze the primary driving evaluation results of a predetermined route (a daily used route) in a predetermined period and acquire a tendency (tendency information) of the evaluation result on the basis of the quantitative analysis result (the collection result in the predetermined period). The primary evaluator 442 estimates a factor (a driving situation type) causing change in details of the acquired tendency information (tendency change). This factor is estimated on the basis of the surrounding environment of the vehicle M, the driving conditions of the driver D, and the schedule information. Then, the primary evaluator 442 refers to the advice information DB 464 using the tendency information and the driving situation type and acquires the advice information and the notification timing information corresponding thereto when they match. For example, when the tendency information in the advice information DB 464 illustrated in FIG. 8 is “a speed limit is violated many and the driving situation type is “driving in a situation in which the weather is fair,” the advice information is “observe the speed limit” and the notification timing is the “morning of a next driving day on which the weather forecast represents fair.” When the tendency information is “the speed limit is violated many” and the driving situation type is “driving in a situation of late night,” the advice information is “take notice of overspeed at night” and the notification timing is “past PM 8:00 in a situation in which the driver has not return home.”

The provider 450 provides the advice information acquired by the primary evaluator 442 to at least one of the vehicle M and the first terminal device 200 at the timing set in the notification timing information. Whether this notification timing is satisfied is determined using various types of information such as the schedule information of the driver D, the position information of the first terminal device 200, and the weather information. In this way, since details of the driving advice or the notification timing of the advice information can be changed according to the driving situation type in spite of the same tendency of driving evaluation, it is possible to provide information with high agreement or acceptability of the driver D.

The provider 450 provides an incentive to a specific person P carrying out secondary driving evaluation on the basis of the number of times or frequency of evaluation or evaluation details. Providing of an incentive is providing various rewards such as free providing or discount of a predetermined service, providing of points, and presentation of a giveaway. Accordingly, the specific person P is motivated to carry out secondary driving evaluation and can easily perform feedback of driving evaluation including the secondary driving evaluation of the driver D. As a result, it is possible to further enhance usefulness of the driving evaluation system 1. The provider 450 may provide a more incentive to a specific person P having carried out the secondary driving evaluation when improvement in safe driving of the driver D is achieved as a result of the secondary driving evaluation. The specific person P is set by the driver D or randomly set out of one or more specific persons, but a specific person P may stand as a candidate for carrying out secondary driving evaluation using the second terminal device 300 for the purpose of acquisition of an incentive. The provider 450 may provide an incentive when a predetermined condition is satisfied such as when it is permitted by the driver D in order to prevent unauthorized acquisition of an incentive. This incentive information may be registered in the driver information DB 461 or may be provided to the second terminal device 300.

The provider 450 may acquire a social score of the driver D from the driver information DB 461 or an external device and update the social score according to the driving evaluation result of the driving behavior of the driver D. For example, since a driver D evaluated to take a good driving behavior acquires a higher score, it is possible to motivate the driver D to carry out safe driving. Since a driver D evaluated to take a bad driving behavior acquires a lower score, it is possible to expect improvement in driving of the driver D. By updating the social score on the basis of the driving evaluation result in this way, it is possible to motivate the driver D to carry out safe driving.

The provider 450 may switch whether to update the social score based on the driving evaluation result according to an instruction from the driver D. Accordingly, it is possible to prevent update of a score undesired by the driver D and to provide a service appropriate for the driver D. The provider 450 may provide an incentive to the driver D according to the social score of the driver D. This incentive information may be registered in the driver information DB 461 or may be provided to the first terminal device 200. Accordingly, it is possible to further motivate the driver D to carry out safe driving.

### [Processing Sequence]

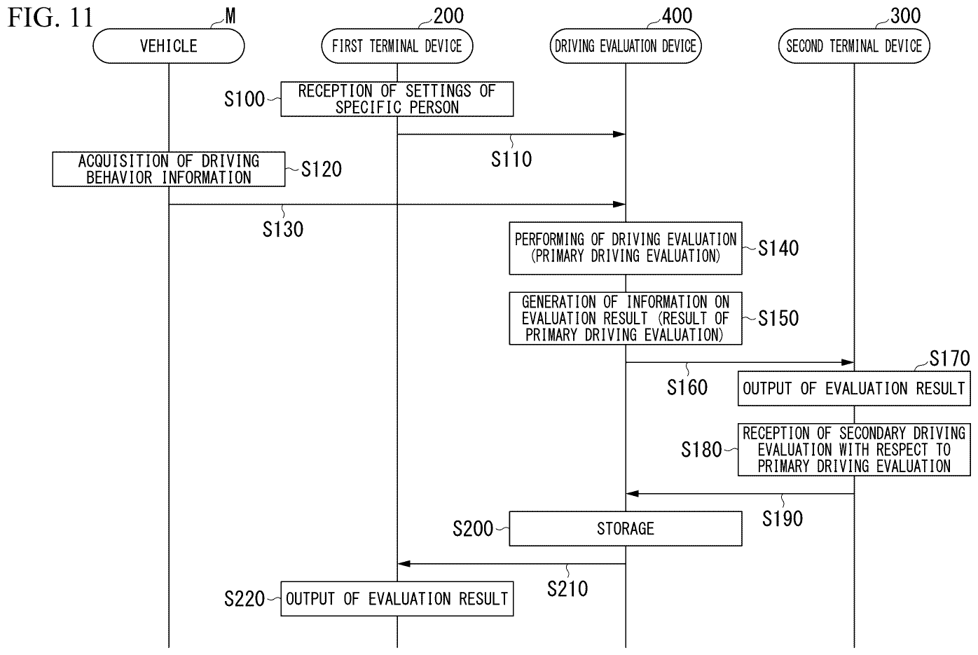

FIG. 11 is a sequence diagram illustrating an example of a processing sequence that is performed by the driving evaluation system 1 according to the embodiment. In the example illustrated in FIG. 11, a sequence of processes in a vehicle M (the vehicle system 100), a first terminal device 200 that is used by a driver D of the vehicle M, the driving evaluation device 400, and a second terminal device 300 that is used by a specific person P is illustrated. In the following description, it is assumed that information on the driver D is registered in the driver information DB 461 of the driving evaluation device 400 in advance.

In the example illustrated in FIG. 11, the first terminal device 200 receives settings of the specific person P from the driver D (Step S100) and transmits the received information of the specific person P to the driving evaluation device 400 (Step S110). The processes of Steps S100 and S110 may be performed before driving or during driving or may be performed after driving. Then, the vehicle M acquires driving behavior information based on driving of the driver D (Step S120) and transmits the acquired driving behavior information (the driving behavior history information 142) to the driving evaluation device 400 (Step S130).

The driving evaluation device 400 performs driving evaluation (primary driving evaluation) for evaluating the driving behavior of the driver D on the basis of the information acquired from the vehicle M (Step S140). Then, the driving evaluation device 400 generates information on the evaluation result (the primary driving evaluation result) (Step S150) and transmits the generated information to the second terminal device 300 of the set specific person P (Step S160).

The second terminal device 300 outputs the evaluation result received from the driving evaluation device 400 to notify the specific person P (Step S170) and receives a secondary driving evaluation result from the specific person P with respect to the primary driving evaluation result (Step S180). Then, the second terminal device 300 transmits the secondary driving evaluation result to the driving evaluation device 400 (Step S190).

The driving evaluation device 400 stores the primary driving evaluation result and the secondary driving evaluation result in the evaluation result DB 463 in correlation (Step S200) and transmits the stored results to the first terminal device 200 at a predetermined timing (Step S210). The first terminal device 200 outputs the driving evaluation result (at least one of the primary driving evaluation result and the secondary driving evaluation result) received from the driving evaluation device 400 to notify the driver D (Step S220). As a result, the process flow of this sequence ends.

In the processing sequence illustrated in FIG. 11, receiving of settings of the specific person P in Step S100 and transmitting of specific person information in Step S110 may be performed by the vehicle M. In the processes of Steps S210 and S220, the primary driving evaluation result and the secondary driving evaluation result may be transmitted to the vehicle M instead of (in addition to) the first terminal device 200, and the evaluation result may be output form the HMI 30 of the vehicle M. Which of the primary driving evaluation result and the secondary driving evaluation result is to be provided is set, for example, by the driver D, but may be set by the specific person P or may be set according to a time period of provision thereof, details of the evaluation result, and the like. To which of the first terminal device 200 and the vehicle M the evaluation result is to be provided can be set in the same way.

### MODIFIED EXAMPLES

A driving evaluation result which is provided to a driver in the embodiment is not limited to the aforementioned example, and another evaluation result may be provided. For example, the provider 450 may present daily details of a driving behavior, statistical results, and the like and may also present information such as a change from the previous day or a change from the previous week. Information on an improved part or a worsened part after driving advice information has been provided may be provided as an evaluation result. When the vehicle departs and travels partially from a normal route due to a traffic jam, a road construction, or the like, the evaluator 440 may exclude the part or the whole route from the driving evaluation and perform primary driving evaluation or the like. By performing this process, for example, daily driving evaluation results in a determined normal route can be comparatively provided, and thus it is possible to further improve agreement or acceptability of a driver with respect to the driving evaluation.

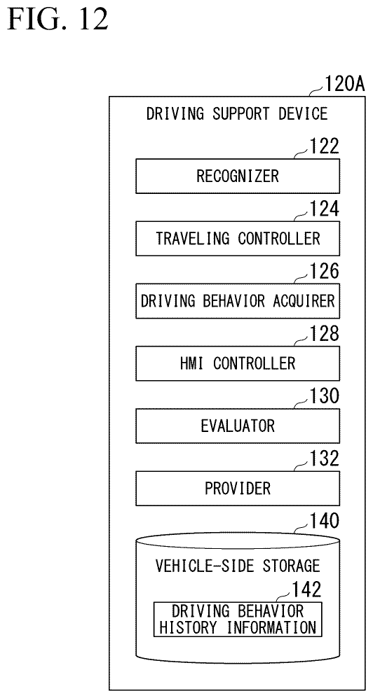

In the embodiment, at least some of the functions of the driving evaluation device 400 may be provided in the vehicle M. For example, at least one of the evaluator 440 and the provider 450 of the driving evaluation device 400 may be provided in the driving support device side of the vehicle M. FIG. 12 is a diagram illustrating an example of functions of a driving support device 120A according to a modified example of the embodiment. The driving support device 120 of the vehicle system 100 illustrated in FIG. 2 is replaced with the driving support device 120A illustrated in FIG. 12. The driving support device 120A includes a recognizer 122, a traveling controller 124, a driving behavior acquirer 126, an HMI controller 128, an evaluator 130, a provider 132, and a vehicle-side storage 140. In the example illustrated in FIG. 12, the driving behavior acquirer 126 is an example of an “acquirer.” The driving support device 120A is different from the driving support device 120 in that the evaluator 130 and the provider 132 are provided. Accordingly, in the following description, the evaluator 130 and the provider 132 will be mainly described, and description of the other functions will be omitted.

Similarly to the aforementioned evaluator 440, the evaluator 130 evaluates a driving behavior of a driver D of a vehicle M on the basis of the driving behavior history information 142. As described above, the evaluation details include primary driving evaluation and secondary driving evaluation. When secondary driving evaluation is performed, the evaluator 130 transmits information including a primary driving evaluation result to a second terminal device 300 of a specific person P which is set in advance, and the second terminal device 300 acquires a secondary driving evaluation result. The provider 132 generates an image, sound, or the like similarly to the provider 450 and outputs the generated image or sound to the HMI 30 or provides the generated image or sound to the first terminal device 200. The provider 132 may provide the driving evaluation result or the driving behavior history information 142 to the driving evaluation device 400 or an external device at a predetermined timing. In this way, according to the modified example, the vehicle system side can realize a driving evaluating process or a provision process.

In the embodiment, at least some of the functions of the driving evaluation device 400 may be provided in the first terminal device 200 or the second terminal device 300. In this case, for example, at least one of the evaluator 440 and the provider 450 of the driving evaluation device 400 may be provided on the terminal device side of the first terminal device 200 or the second terminal device 300, and the application executor thereof may perform a driving evaluation application to perform the processes of the evaluator 440 or the provider 450. Accordingly, the terminal device side can realize the driving evaluation process or a provision process.

At least a part of the configuration of the driving evaluation system 1 according to the embodiment may be provided abroad (overseas). For example, when the driving evaluation device 400 in the configuration of the driving evaluation system 1 according to the embodiment is provided domestically and the second terminal device 300 is provided abroad, the secondary driving evaluation result is acquired from abroad. When the driving evaluation device 400 is provided domestically and the first terminal device 200 or the vehicle M is provided abroad, the driving behavior history information 142 is acquired from abroad.

As described above, according to an embodiment, the driving evaluation system 1 includes a vehicle M, a first terminal device 200 that is used by a driver D of the vehicle M, a second terminal device 300 that is used by a specific person P correlated with the driver D, and a driving evaluation device 400 that evaluates a driving behavior of the driver D. The driving evaluation system 1 further includes an acquirer 430 configured to acquire information on the driving behavior of the driver D, an evaluator 440 configured to evaluate the driving behavior of the driver D on the basis of the information acquired by the acquirer 430, and a provider 450 configured to provide an evaluation result from the evaluator 440 to at least one of the vehicle M and the first terminal device 200 that is used by the driver D. The provider 450 provides the evaluation result from the evaluator 440 to at least one of the vehicle M and the first terminal device 200 via the second terminal device 300 that is used by the specific person P correlated with the driver D. Accordingly, it is possible to further improve agreement or acceptability of a driver with respect to the driving evaluation.

According to the embodiment, by notifying the specific person concerned of the driver of a result of primary driving evaluation, it is possible to improve agreement or acceptability of a driver D with respect to the driving evaluation result through support of a high-reliability person or feedback of sympathy or resonance thereof. According to the embodiment, since the driver D can arbitrarily select, for example, two types of evaluation results including the primary driving evaluation result based on the driving behavior and the secondary driving evaluation result to which feedback of a specific person sharing the primary driving evaluation result has been added, it is possible to easily obtain a desired driving evaluation result and to improve usability. According to the embodiment, for example, since the driver can arbitrarily set or change the specific person performing the secondary driving evaluation, it is possible to improve usability by extending the secondary driving evaluation and to achieve security enhancement such as prevention of unauthorized use by a third party. According to the embodiment, it is possible to estimate how the evaluation result is affected by disturbance factors or the like by accumulating results of driving evaluation performed using normally used routes and performing statistical analysis processes. Since an appropriate driving behavior can be advised in a scene or situation which is likely to be affected by disturbance factors as a result of analysis, it is possible to further improve acceptability. According to the embodiment, by using the weather or the temperature detected by a sensing device, the night or daytime detected, driver conditions detected by a biological sensor, a time schedule of a driver, and the like as disturbance factors, it is possible to enhance the quality of driving advice information (such as contents). According to the embodiment, it is also possible to allow a third party to analyze fluctuation of driving evaluation due to road conditions by allowing the third party to use the driving evaluation device 400.

The above-mentioned embodiment can be expressed as follows:

A driving evaluation device including:
a storage medium configured to store computer-readable instructions; and
a processor connected to the storage medium,
wherein the processor executes the computer-readable instructions to perform:
acquiring information on a driving behavior of a driver of a vehicle;
evaluating the driving behavior of the driver on the basis of the acquired information; and
providing an evaluation result to at least one of the vehicle and a first terminal device that is used by the driver via a second terminal device that is used by a specific person correlated with the driver.

While an embodiment of the present invention has been described above, the present invention is not limited to the embodiment and can be subjected to various modifications and substitutions without departing from the gist of the present invention.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A driving evaluation system comprising a vehicle, a first terminal device that is used by a driver of the vehicle, a second terminal device that is used by a specific person correlated with the driver, and a driving evaluation device that evaluates a driving behavior of the driver, the driving evaluation system further comprising:
an acquirer configured to acquire information on the driving behavior of the driver;
an evaluator configured to evaluate the driving behavior of the driver on the basis of the information acquired by the acquirer; and
a provider configured to provide an evaluation result from the evaluator to at least one of the vehicle and the first terminal device that is used by the driver,
wherein the provider provides the evaluation result from the evaluator to at least one of the vehicle and the first terminal device via the second terminal device that is used by the specific person correlated with the driver.

2. A driving evaluation device comprising:
an acquirer configured to acquire information on a driving behavior of a driver of a vehicle;
an evaluator configured to evaluate the driving behavior of the driver on the basis of the information acquired by the acquirer; and
a provider configured to provide an evaluation result from the evaluator to at least one of the vehicle and a first terminal device that is used by the driver,
wherein the provider provides the evaluation result from the evaluator to at least one of the vehicle and the first terminal device via a second terminal device that is used by a specific person correlated with the driver.

3. The driving evaluation device according to claim 2, wherein the evaluator acquires a result of primary driving evaluation for evaluating the driver's driving behavior on the basis of the information acquired by the acquirer and a result of secondary driving evaluation for allowing the specific person to evaluate the driver's driving behavior in the result of primary driving evaluation, and
wherein the provider provides at least one of the result of primary driving evaluation and the result of secondary driving evaluation to at least one of the vehicle and the first terminal device on the basis of a request from the driver.

4. The driving evaluation device according to claim 2, further comprising a register configured to register information of one or more specific persons,
wherein the provider provides the evaluation result from the evaluator to the second terminal device which is used by the specific person designated by the driver out of the one or more specific persons registered in the register.

5. The driving evaluation device according to claim 2, wherein the evaluator quantitatively analyzes the driver's driving behavior in a route which is used daily by the driver, estimates a factor causing change of evaluation of the driving behavior on the basis of a result of analysis, and determines at least one of details of driving advice for the driver and a timing at which the driver is notified of the driving advice on the basis of a result of estimation.

6. The driving evaluation device according to claim 5, wherein the acquirer acquires a surrounding environment of the vehicle and schedule information of the driver, and
wherein the evaluator estimates the factor causing change of evaluation of the driving behavior on the basis of the result of analysis, the surrounding environment, the driver's driving conditions included in the information on the driving behavior, and the schedule information.

7. The driving evaluation device according to claim 3, wherein the provider provides an incentive to the specific person who has performed the secondary driving evaluation.

8. The driving evaluation device according to claim 2, wherein the acquirer acquires a social score for the driver, and
wherein the provider updates the social score according to the result of evaluation of the driver's driving behavior.

9. The driving evaluation device according to claim 8, wherein the provider provides an incentive to the driver according to the social score of the driver.

10. A driving evaluation method that is performed by a computer, the driving evaluation method comprising:
acquiring information on a driving behavior of a driver of a vehicle;
evaluating the driving behavior of the driver on the basis of the acquired information; and
providing an evaluation result to at least one of the vehicle and a first terminal device that is used by the driver via a second terminal device that is used by a specific person correlated with the driver.

11. A non-transitory computer-readable storage medium storing a program, the program causing a computer perform:
acquiring information on a driving behavior of a driver of a vehicle;
evaluating the driving behavior of the driver on the basis of the acquired information; and
providing an evaluation result to at least one of the vehicle and a first terminal device that is used by the driver via a second terminal device that is used by a specific person correlated with the driver.
